(19) United States
(12) Patent Application Publication
(10) Pub. No.: US 2016/0217776 A1
(43) Pub. Date: Jul. 28, 2016

(54) PERCUSSION MUSICAL INSTRUMENT

(71) Applicants: Eddy Allan BALMA, Ubud-Bali (ID); David Frederick McDEVITT, Ubud-Bali (ID); Kalani DAS, Granada Hills, CA (US)

(72) Inventors: Eddy Allan BALMA, Ubud-Bali (ID); David Frederick McDEVITT, Ubud-Bali (ID); Kalani DAS, Granada Hills, CA (US)

(21) Appl. No.: 14/001,063

(22) PCT Filed: Aug. 22, 2013
(86) PCT No.: PCT/US2012/026204

§ 371 Date: Aug. 22, 2013

Related U.S. Application Data
(60) Provisional application No. 61/445,531, filed on Feb. 22, 2011.

(51) Int. Cl. G10D 13/02

(52) U.S. Cl. CPC G10D 13/027; G10D 13/028

(57) ABSTRACT

A drumhead that is removably fitted onto a drum shell and seated in a rubber ring to create a seal to form a percussion instrument is disclosed. The percussion instrument thus formed does not require any hardware, rope, or adhesives applying tension to hold the drumhead to the drum shell to create a normal percussive sound.

### BACKGROUND OF THE DISCLOSURE

1. Field of the Disclosure

The present disclosure relates to percussion musical instruments. In particular, the present disclosure relates to a drumhead that is seated on a drum shell to form a percussion instrument having an airtight seal that creates a normal percussive sound, without the need to use tensioning devices. The drumhead is easily removed from, and placed on, the drum shell.

2. Description of the Related Art

Various types of drumheads and drum mounting assemblies are known in the art of musical instruments. Drum skins are generally attached to the drum shell using metal hooks rings or screws or configurations of rope tying or tacks or glue. Once the drum skins are fixed to the shell it is time-consuming to remove them and therefore is generally not done.

Traditional drumhead assemblies apply tension to the skin as they are tightened onto the shell creating the vibrations needed for the drum to produce a good tone. When this skin is removed from the shell it has little or no sound producing qualities.

### SUMMARY OF THE DISCLOSURE

The present disclosure provides a drumhead that can be easily placed on, removed, and replaced on a drum shell. The drum shell has a soft rubber ring around the entire upper rim in which the drumhead is seated to create a tight seal that permits compression when striking the drumhead to create a proper drum sound, without the use of glue, rope, or metal fixing screws, or other conventional device that otherwise applies tension to hold the drumhead tightly on the drum shell.

The present disclosure further provides a pre-tensioned drumhead that has the flexibility of drum skin. Further, the drumhead can be removed from the drum shell to become a second percussion instrument.

The present disclosure further provides a pre-tensioned removable drumhead that, when removed from the drum shell, allows the drum shell to be stacked inside a second drum shell that has had the drumhead removed, to save space for storage and transport.

### BRIEF DESCRIPTION OF THE DRAWINGS

FIG. 1 is a perspective view illustrating two major components of a percussion instrument of the present disclosure, the drumhead and drum shell, where the drumhead is separated from the drum shell.

FIG. 2 is an illustration of the drum shell in FIG. 1, with FIG. 2A showing an enlarged view of a rubber ring around the circumference of the upper edge of the drum shell, and FIG. 2B showing an enlarged view of a second rubber ring around the circumference of the bottom edge of the drum shell.

FIG. 3 is a perspective view of the percussion instrument in FIG. 1, where the drumhead is seated and sealed on the drum shell to form the percussion instrument.

FIG. 4 is a cross-section of the percussion instrument in FIG.3, with FIG. 4A showing an enlarged view of the rubber ring around the top lip of the drum shell, and FIG. 4B showing an enlarged view of the rubber ring around the lower lip of the drum shell.

FIG. 5 is a perspective view of two of the drum shells as shown in FIG. 1, with their drumheads removed, and with one drum shell that is stacked inside the other.

FIG. 6 is a cross-section of the two drum shells in FIG. 5, stacked one inside the other, with FIG. 6A showing an enlarged view of the top corner of the uppermost drum, and FIG. 6B showing an enlarged view of the point inside the stacked drum shells where the bottom of the upper drum shell touches the side walls of the lower drum shell.

FIG. 7 is a top perspective view of the drumhead in FIG. 1, illustrating a second drumhead that is stacked on the first drumhead.

FIG. 8 is a cross-section of the two stacked drumheads in FIG. 7, with FIG. 8A showing an enlarged view of the side area where a lower portion of the second drumhead overlaps the top portion of the first drumhead.

FIG. 9 is a perspective view of the percussion instrument in FIG. 1, showing an exemplary embodiment of a finished percussion instrument.

FIG. 10 is a bottom view of the underside of the drumhead in FIG. 9, after removal of the drumhead from the drum shell.

FIG. 11 is a perspective view of three percussion instruments like those in FIG. 9 where the drumheads have been removed from each drum shell, and where the three drum shells are stacked together, one inside the other, and the drumheads are also stacked together.

### DETAILED DESCRIPTION OF THE DISCLOSURE

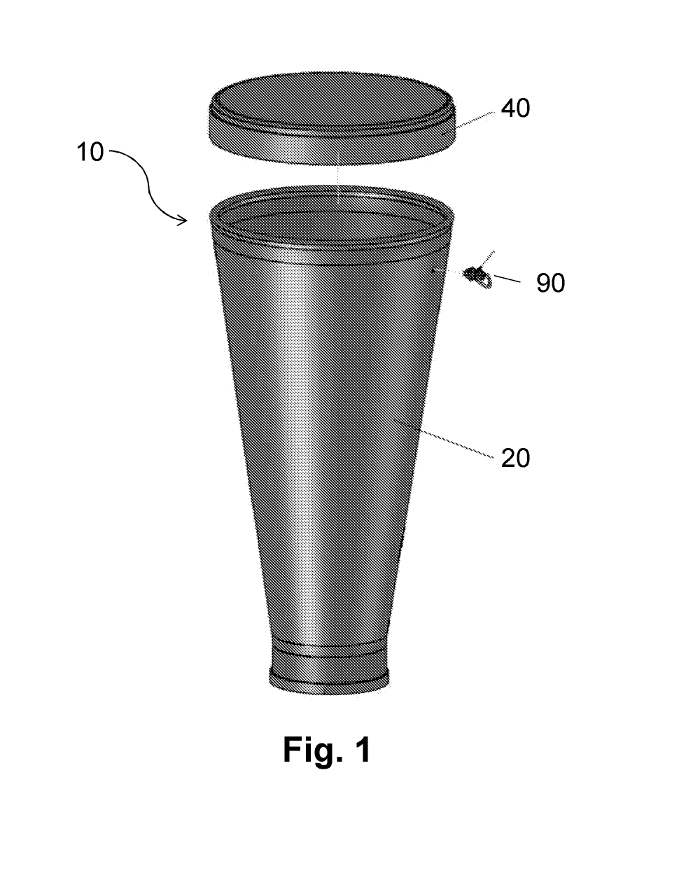

Referring to the drawings, and in particular, FIGS. 1 to 3, there is provided a percussion musical instrument generally represented by reference number 10. Percussion instrument 10 is formed by a drum shell 20, and a drumhead 40 that is connected to the open top of drum shell 20, without the use of tensioning agents such as glue, rope, nails or hardware (such as metal fixing screws) to hold drumhead 40 on drum shell 20. Drum shell 20 has a circumferential upper edge 22 that forms an upper opening 28. A flexible ring 60, which is typically made of rubber but can be made of any flexible, sealable material, is positioned around the circumference of upper edge 22 on which drumhead 40 is seated to form percussion instrument 10, such that flexible ring 60 forms an airtight seal between drumhead 40 and drum shell 20 that creates a normal or proper percussive sound when pressure is applied to drumhead 40. Drumhead 40 can be easily removed from drum shell 20 by pulling upwardly on one portion of drumhead 40 to break the seal formed with flexible ring 60. The percussion instrument 10 can be re-assembled as often as desired by reconnecting the drumhead and drum shell. As shown in FIG. 1, drum shell 20 can have a bolt set 90 on the side for ease of carrying, but bolt set 90 is not involved with securing and sealing drumhead 40 to drum shell 20.

Once removed from drum shell 20, drumhead 40 becomes a second percussion instrument. In this way, the percussion instrument is, in effect, two percussion instruments in one.

Once drumhead 40 is removed from drum shell 20, two or more drum shells are stackable, one inside each other. This arrangement saves space and provides greater ease in storage or transport of the percussion instrument(s), as compared to storing or transporting the percussion instruments as individual instruments.

Drum shell 20 is made of any material used for drum bodies, including, but not limited to, polyvinyl chloride (PVC), wood, fiberglass, and any combinations thereof. A preferred embodiment of a drum shell is made of PVC. Drum shell 20 typically has a smooth outer surface.

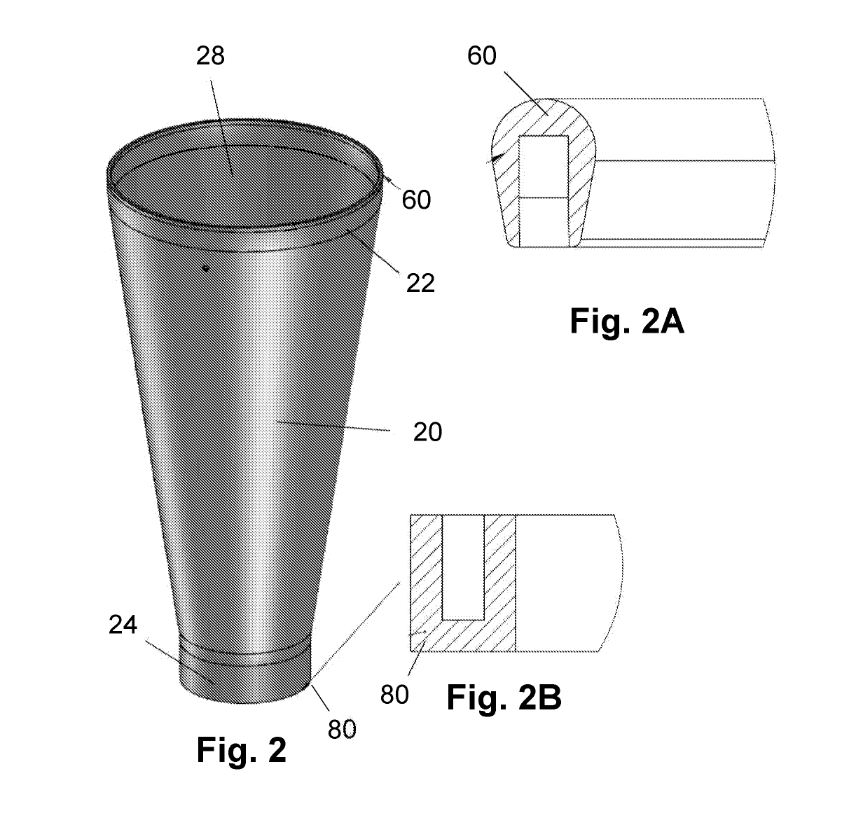

Referring to FIG. 2, an exemplary embodiment of drum shell 20 is shown without drumhead 40, revealing an upper rubber ring 60 that extends around upper edge 22 of drum shell 20. A second, lower rubber ring 80 extends around a lower edge 24 of drum shell 20.

Upper rubber ring 60 is positioned on and over the sides of upper edge 22 around the entire perimeter of opening 28 of drum shell 20. As shown in the enlarged view in FIG. 2A, an exemplary embodiment of upper rubber ring 60 has a U-shape that allows upper rubber ring 60 to be pressed down on upper edge 22, and to remain in that position without glue or fasteners. In this embodiment, upper rubber ring 60 has a rounded top surface that provides a smooth surface on which to seat drumhead 40. Similarly, as shown in enlarged view FIG. 2B, lower rubber ring 80 also has a U-shape that permits the ring to be pressed on and over the sides of lower edge 24, and to remain in position without glue or fasteners. An exemplary embodiment of lower rubber ring 80 has a U-shape with squared edges, to provide a stable platform for drum shell 20.

Upper rubber ring 60 is typically made of a soft rubber. The rubber ring creates a seal, much like a gasket. The thickness of the rubber ring is typically about 7 mm±4 mm, but can be thicker or thinner, depending on the gap between the drumhead and drum shell.

Rubber ring 60 can be lubricated to create a better, firmer seal when drumhead 40 is seated on upper lip 22 of drum shell 20. Examples of lubricants that can be used on the rubber ring include, but are not limited to, compositions containing siloxanes and silicones, such as STP SON OF A GUN® PROTECTANT (Armor All/STP Products Co., Danbury, Conn.) and KIT TIRE FOAM (S.C. Johnson & Sons, Inc., Racine, Wis.). The lubricant is applied to one side, or to both sides, of the rubber ring.

Drumhead 40 can have a ring (not shown) that is formable and strong enough to hold a stretched drum skin, including, but not limited to, polyvinyl chloride (PVC), wood, fiberglass, and any combinations thereof. In an exemplary embodiment, an internal ring of polyvinyl chloride (PVC) that extends around the inner circumference of drumhead 40 can be used. This is an example of a pre-tensioned drumhead. A removable, pre-tensioned drumhead 40 can be used for any percussion instrument of the present disclosure, including, but not limited to, a hand drum.

The stretched drum skin is connected around the periphery of the ring and extends across the ring to form a percussive instrument. The drum skin generates a percussive sound or vibration when struck with a stick, mallet, or hand. The drum skin can be made of any material that can generate a percussive sound, including, but not limited to, plastic, Mylar, Kevlar or other aramid fibers, fiberglass, polyester, animal skins, and any combinations thereof. A preferred embodiment has a drum skin that is made of Mylar.

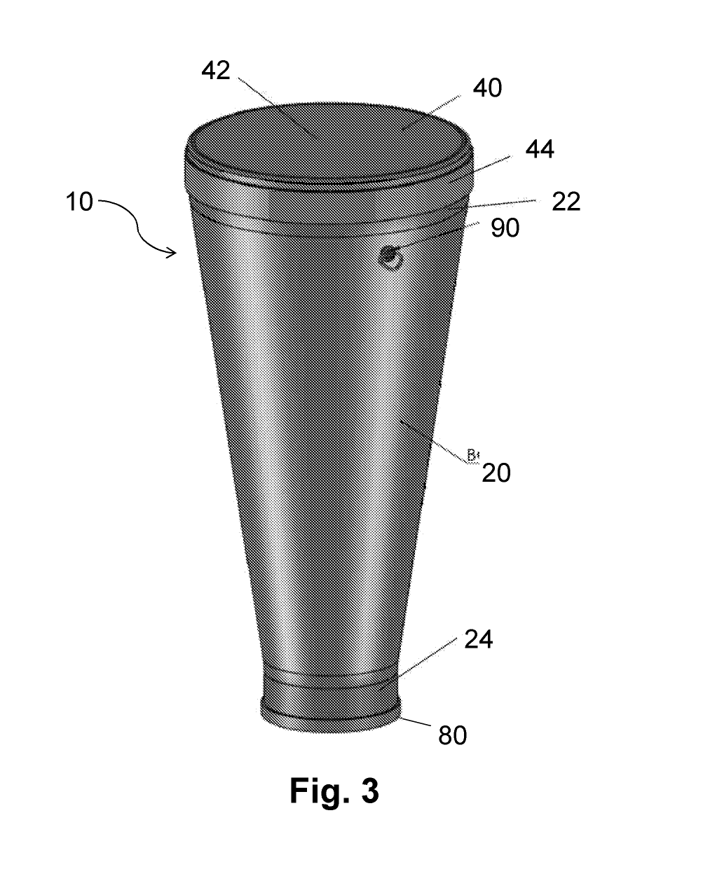

In FIG. 3, percussion instrument 10 is formed by seating drumhead 40 onto drum shell 20. Drum shell 20 has an upper edge 22 that forms a lip. Ring 60 (not shown) is positioned over and around the lip of upper edge 22. Drum shell 20 also has a bottom edge 24 that has a bottom lip, around which lower rubber ring 80 is positioned. Drumhead 40 has a pre-tensioned drum skin 42, and an outer edge 44.

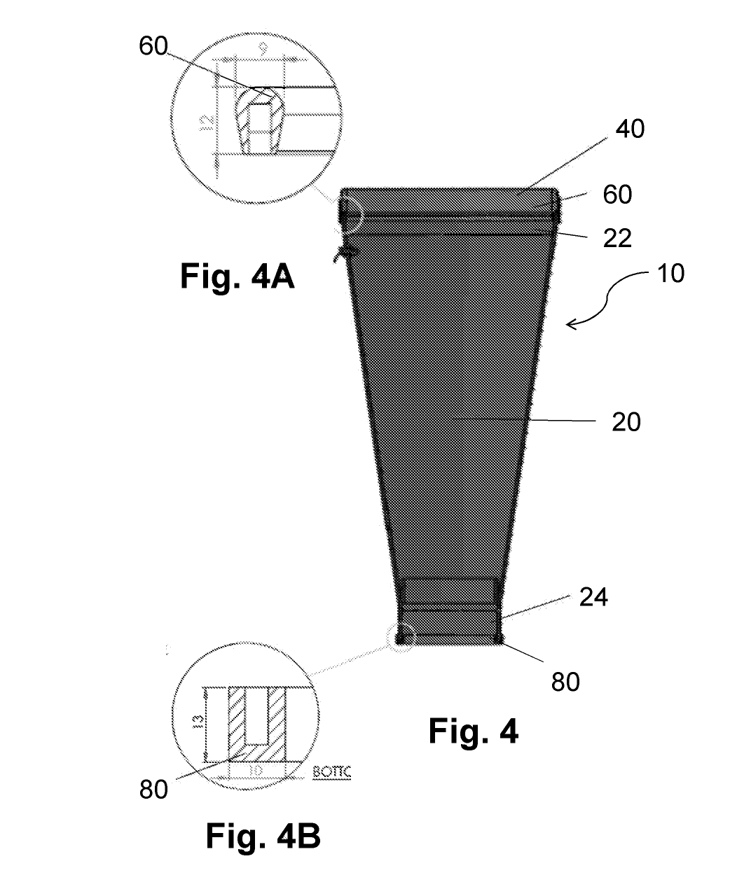

In FIG. 4, a cross-section of percussion instrument 10 is shown. The enlarged section in FIG. 4A shows the U-shaped rubber ring 60 that is placed around and over the lip of upper edge 22. The enlarged section in FIG. 4B shows lower rubber ring 80 that is positioned around and over lower edge 24. Rubber ring 80 has a squared-off U-shape to provide a stable platform for percussion instrument 10.

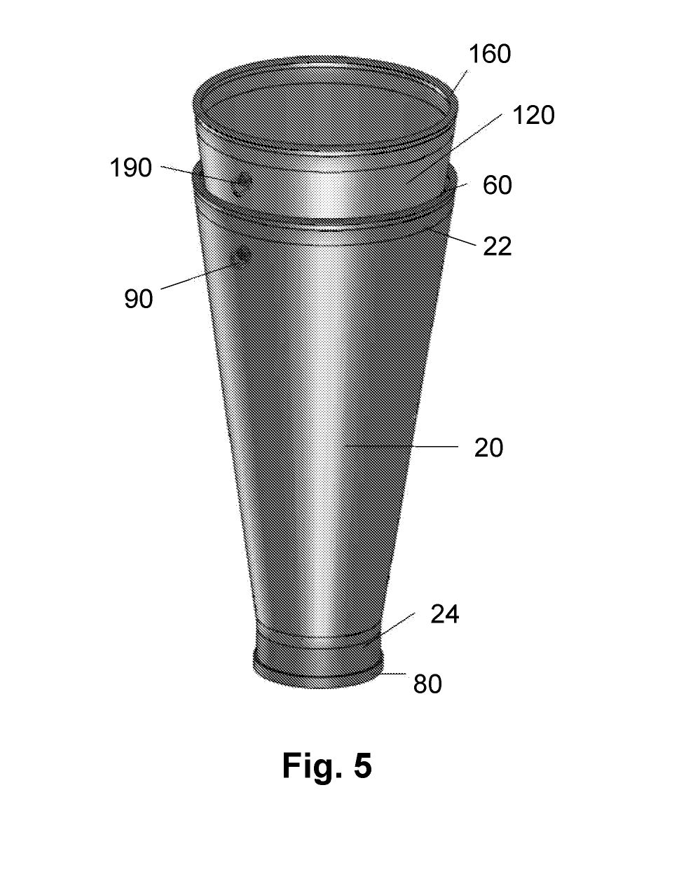

In FIG. 5, two drum shells (without drumheads) are shown stacked on inside the other. Specifically, drum shell 120 is placed in drum shell 20. Drum shell 120 has an upper rubber ring 160 and bolt set 190 that correspond to rubber ring 60 and bolt set 90 for drum shell 20.

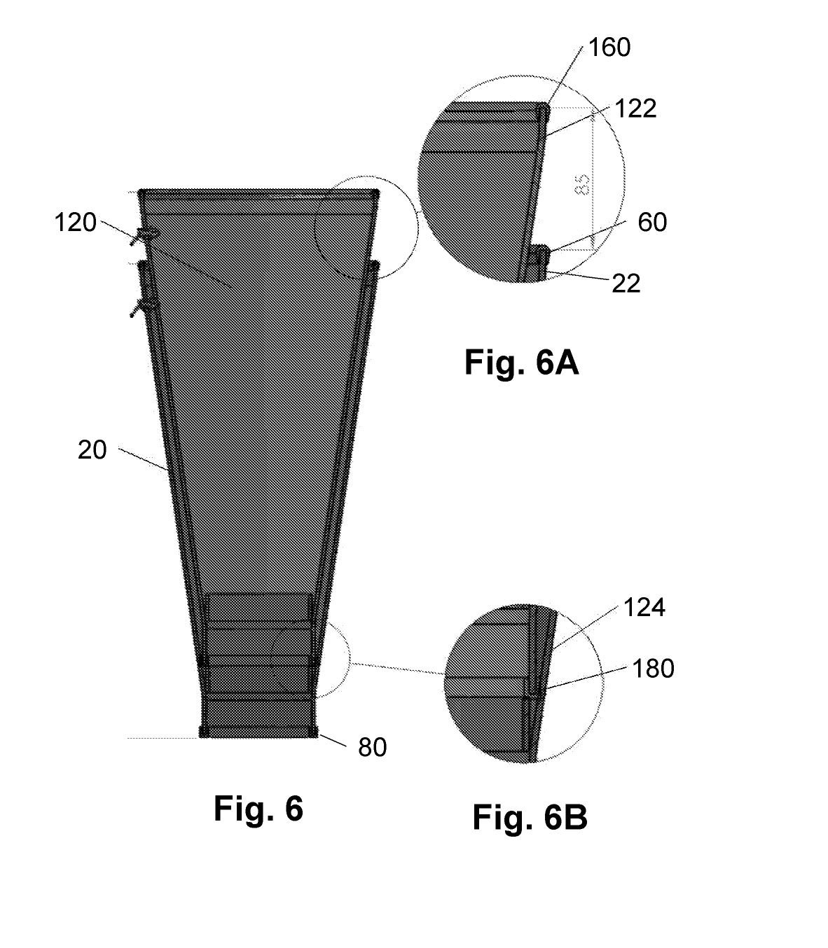

FIG. 6 is a cross-section of two drum shells in FIG. 5 that are stacked together. The enlarged are in FIG. 6A shows clearly the rubber ring 60 around and over the lip of upper edge 22 for drum shell 20, and, similarly, rubber ring 160 is positioned around and over the lip of upper edge 122 of drum shell 120. FIG. 6B is an enlarged area showing that rubber ring 180 of drum shell 124 is positioned along the inner wall of drum shell 20, which stops drum shell 120 from moving any further down.

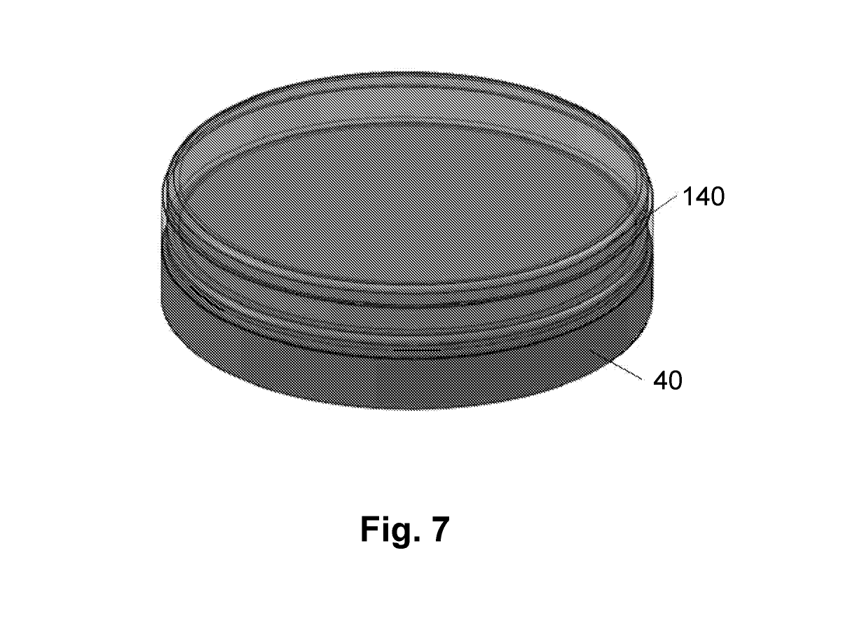

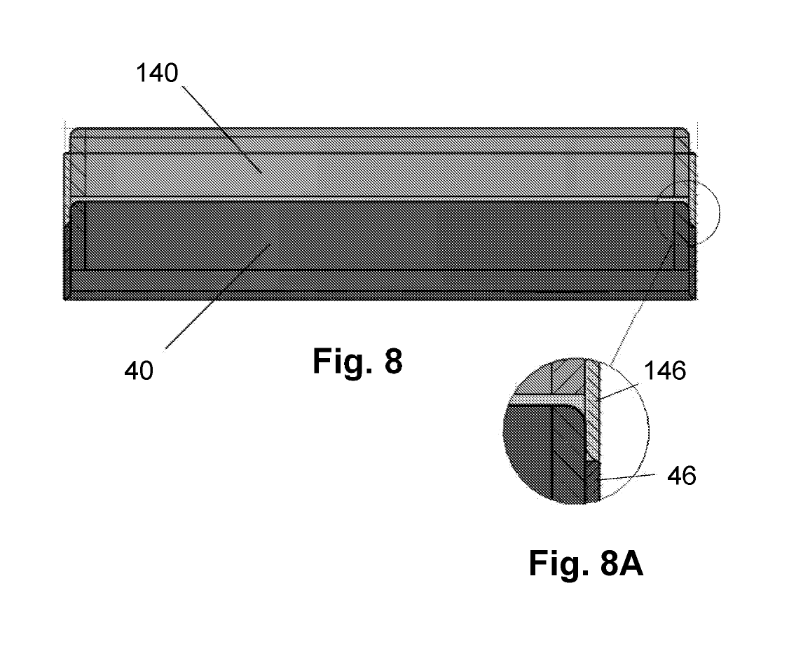

FIG. 7 shows two drumheads, 40, 140, that are stacked, one on the other. FIG. 8 shows a cross-section of the drumheads in FIG. 7, with an enlarged view of the recessed lip 46 and 146, respectively.

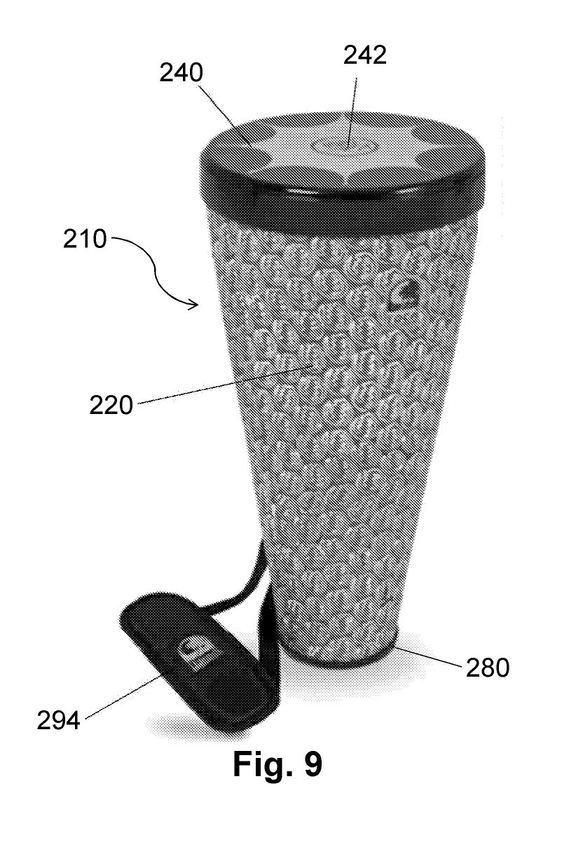

FIG. 9 shows a finished commercial percussion instrument 210 of the present disclosure. Percussion instrument 220 is formed by drum shell 220 and drumhead 240, with pretensioned drum skin 42. A lower rubber ring 280 is shown. Carrying strap 294 is also provided.

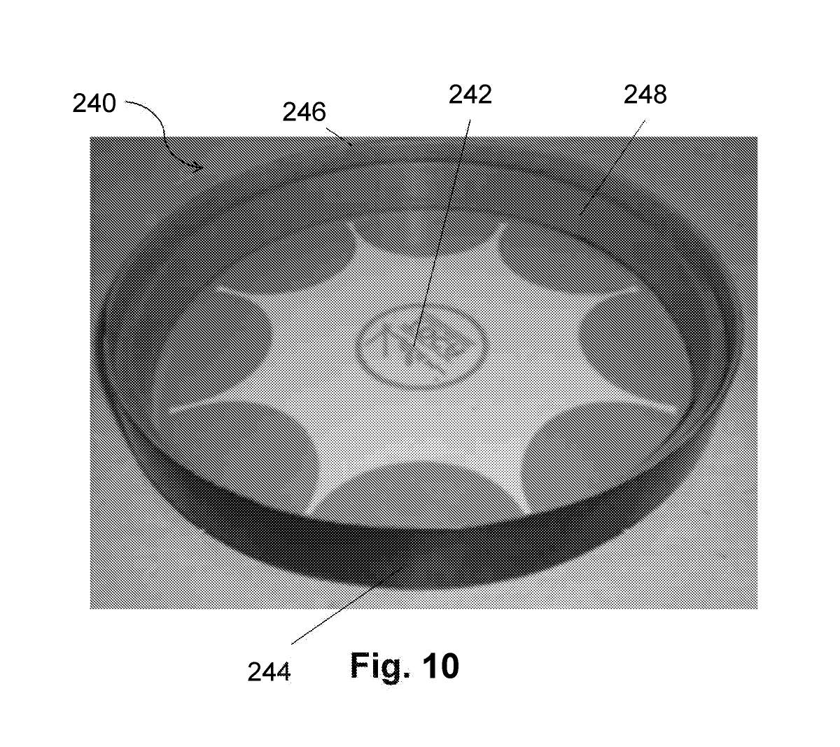

FIG. 10 shows a detail of the underside of drumhead 240, that has an interior circumference 246, and a smaller inner circumference 248 that form a peripheral recessed interior step. When drumhead 240 is placed on drum shell 220, the rubber ring is received by the peripheral recessed interior step, and the rubber ring positioned therebetween (not shown) forms the seal between the lip of the drum shell and the interior step to form percussion instrument 210 that has a proper percussive sound, without need of any tensioning devices.

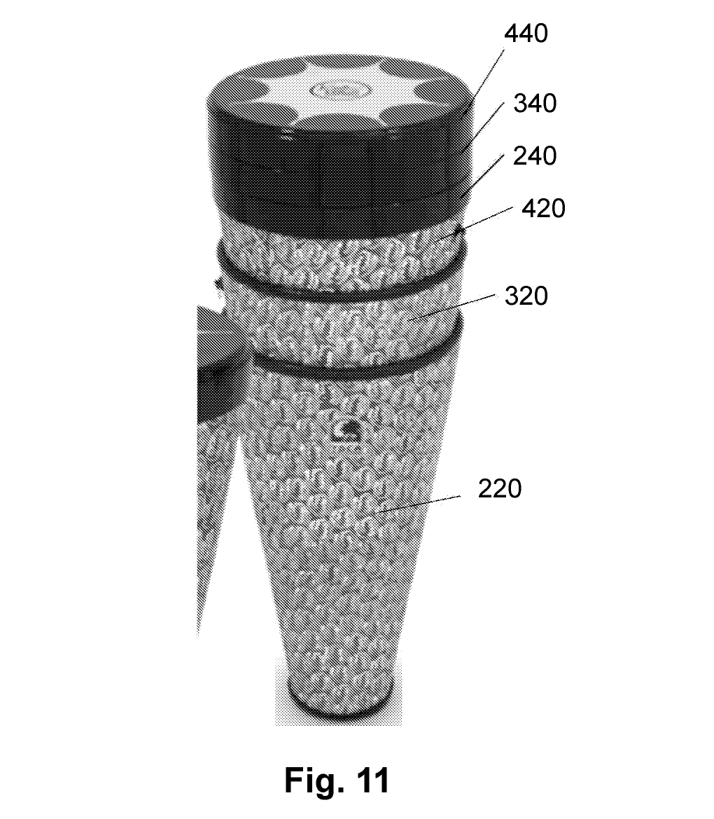

FIG. 11 shows three finished commercial products stacked together, with drum shells 220, 320 and 420 stacked together, and drumheads 240, 340, and 440 stacked together, respectively. This arrangement saves space during storage and transport of the percussion instruments.

When the drumhead is placed on the drum shell and pressed down until the drumhead is seated on the drum shell, the rubber ring on the upper edge of the drum shell and the inner ring of PVC of the drumhead connect to form an airtight seal and seamless bond. The airtight seal thus formed is sufficient to seat the drumhead in place and to maintain its position unless and until the drumhead is forcibly pulled off the drum shell. The connection of the drumhead and drum shell does not use any hardware, such as screws or nails, glue, rope, or any combinations thereof, to apply tension to hold the drumhead onto the drum shell.

A benefit of the present disclosure is that the drumhead and drum shell are removably connected; i.e., by pulling upwardly on the drumhead, the airtight seal formed by the rubber ring of the drum shell and the inner ring of the drumhead is disrupted, and the drumhead is then readily removed (“popped off”) from the drum shell.

The seal formed by the rubber ring on the upper edge of the drum shell and the inner ring of the drumhead provides the benefit of a proper percussion sound. If a drumhead were simply pushed down on a drum shell (without forming a seal), there would not be the ability to create a proper percussion sound. Compression from striking the drumhead provides a bass sound. If there is a hole or break in the drum shell, even a small hole or break, the compression can be compromised or lost, and the drum does not produce a proper percussive sound.

When the drumhead is removed from the drum shell, the drumhead itself becomes a percussion instrument, and can be struck by the hand, stick or mallet to produce a percussive sound. Thus, the drum of the present disclosure is actually two instruments in one.

The drum shells of the present disclosure (when the drumheads are not connected), can be stacked together, one inside the other. This can be done for two or more drum shells of the present disclosure. The stacking of drum shells saves space when storing or transporting drums.

In an exemplary embodiment of the drum shell (stackable drum body) and drumhead (frame drum), the external edge of the drumhead (frame drum) is about 298 mm at its longest point across the center of the drum. When the drumhead is removed, the dimension of the rubber ring around the upper edge of the drum shell is about 292 mm from outside edge to outside edge, and about 280 mm from inside edge to inside edge. The thickness of the rubber ring itself is about 7 mm. The internal edge diameter from inner edge to inner edge is about 292 mm. The inner ring of PVC in the drumhead is about 7 mm thick, as shown. The internal diameter of the drumhead is about 278 mm from the inside of the inner PVC ring across the center of the drumhead to the inside surface of the inner PVC ring at the opposite side. When the drumhead is placed right-side-up on the open upper edge of the drum shell and pressed down so that the inner PVC ring of the drumhead engages the rubber ring on the drum shell to form an airtight seal, the percussion instrument of the present disclosure is formed.

In this way, the drumhead and drumhead can be formed to create a percussion instrument of any size, from very small to very large. As long as the drumhead is sized to form an airtight seal when connected with the drum shell, there is no limitation on the size of the drum.

When the performance is completed, or if the performer desires to play just the drumhead as a separate instrument, the drum can be disassembled into its component parts by pulling upwardly on the drumhead until the drumhead disengages (“popped off”) from the drum shell. The drumhead may then be played as a separate percussion instrument, or, if the performance is over, placed loosely on the stacked drum shells.

In this application, the term “drumhead” is used interchangeably with “frame drum,” or “pre-tensioned drumhead” without any difference in meaning.

In this application, the term “drum shell” is interchangeably referred to as “drum body,” “stackable drum body” or “stackable body,” without any difference in meaning.

As used in this disclosure, the word “about” for temperatures, dimensions, weights, angles, and other measures, means a range that is ±10% of the stated value, more preferably ±5% of the stated value, and most preferably ±1% of the stated value, including all subranges therebetween.

It should be understood that the foregoing description is only illustrative of the present disclosure. Various alternatives, combinations and modifications can be devised by those skilled in the art without departing from the disclosure. Accordingly, the present disclosure is intended to embrace all such alternatives, modifications and variances that fall within the scope of this description.

What is claimed is:

1. A percussion instrument comprising:
a drum shell having an upper edge that forms an opening for the drum shell;
a drumhead adapted to be removably seated on the upper edge of the drum shell; and
a soft and flexible ring positioned on the upper edge, so that when the drumhead is seated in position on the drum shell, the ring forms a seal therebetween so that the percussion instrument retains an otherwise normal percussive sound.

2. The percussion instrument of claim 1, wherein the seal is an airtight seal.

3. The percussion instrument of claim 1, wherein the ring is about 7 millimeters in thickness.

4. The percussion instrument of claim 1, wherein the ring is U-shaped.

5. The percussion instrument of claim 1, further comprising a lubricant applied to the ring.

6. The percussion instrument of claim 1, wherein the lubricant is applied to both sides of the ring.

7. The percussion instrument of claim 1, wherein the ring is made of rubber.

8. The percussion instrument of claim 1, wherein the drum shell has a smooth outer surface.

9. The percussion instrument of claim 1, wherein the upper edge has a lip.

10. The percussion instrument of claim 1, wherein the ring is positioned in the lip.

11. The percussion instrument of claim 1, wherein the drum shell has an open bottom end opposite the upper edge.

12. The percussion instrument of claim 11, wherein the bottom end has a second ring that seals a bottom to the bottom end.

13. The percussion instrument of claim 1, wherein the upper edge retains the ring about the edge so that when the drumhead is placed in the drum shell, the airtight seal is formed.

14. The percussion instrument of claim 1, wherein the drumhead has an inner circumference and a second, smaller inner circumference that form an interior, recessed peripheral step.

15. The percussion instrument of claim 14, wherein the recessed peripheral step receives the ring when the drumhead is placed on the drum shell.

16. The percussion instrument of claim 14, wherein a lip of the upper edge and the recessed peripheral step form a mating engagement so that the ring positioned therebetween creates an airtight seal.

17. The percussion instrument of claim 16, wherein the drumhead is secured onto the drum shell in a “snap-fit” connection.

18. A percussion instrument comprising:
a drum shell having an upper edge that forms an opening for the drum shell;
a pretensioned drumhead removably seated on the upper edge of the drum shell; and
a soft, flexible rubber ring positioned on the upper edge, so that when the drumhead is seated in position on the drum shell, the ring forms a seal therebetween, so that the drumhead is not tensioned onto the drum shell.
